(19) United States
(12) Patent Application Publication
(10) Pub. No.: US 2013/0158779 A1
(43) Pub. Date: Jun. 20, 2013

(54) METHOD FOR OPERATING A FAULT DIAGNOSIS SYSTEM OF A VEHICLE AND VEHICLE

(71) Applicant: GM Global Technology Operations LLC, Detroit, MI (US)

(72) Inventors: Michael Gloos, Darmstadt (DE); Philipp Peti, Ruesselsheim (DE)

(73) Assignee: GM GLOBAL TECHNOLOGY OPERATIONS LLC, Detroit, MI (US)

(21) Appl. No.: 13/714,084

(22) Filed: Dec. 13, 2012

(30) Foreign Application Priority Data
Dec. 16, 2011 (DE) 102011121441.4

(51) Int. Cl. G06F 17/00

(52) U.S. Cl. CPC G06F 17/00
USPC 701/33.4

(57) ABSTRACT

A method for operating a fault diagnosis system of a vehicle is provided. The vehicle includes a plurality of electronic components and a plurality of vehicle systems. At least one of the plurality of vehicle systems can be operated by means of at least two of the plurality of electronic components. The method includes determining if at least one of the plurality of electronic components comprises a fault condition, and if it is determined that at least one of the plurality of electronic components comprises a fault condition, a determining as to which of the vehicle systems that is operable by means of the electronic component comprising the fault condition, has caused the fault condition. In addition, a determining of an identification code that is assigned to the vehicle system causing the fault condition, takes place. Furthermore, a storing of a fault entry that includes the identification code takes place.

### CROSS-REFERENCE TO RELATED APPLICATIONS

This application claims priority to German Patent Application No. 10 2011 121 441.4, filed Dec. 16, 2011, which is incorporated herein by reference in its entirety.

### TECHNICAL FIELD

The application pertains to a method for operating a fault diagnosis system of a vehicle, a vehicle having a fault diagnosis system, a computer program product and a computer-readable medium.

### BACKGROUND

From DE 199 83 537 T1 a method and a system for the fault diagnosis relating to network systems are known, in particular for electrical network systems in vehicles. The network system in its entirety is systematically documented in a database as a number of mutually autonomous user functions, of which each brings with it a functionality of a value that is perceptible by the user. These user functions are documented in a chain of sub-functions, wherein a plurality of sub-functions can occur in a plurality of user functions, the user functions of which are then called overlapping function domains. This documentation is used for fault elimination in order to exclude non-defective sub-functions from the further fault elimination in the case of defective user functions.

In addition, other objects, desirable features and characteristics will become apparent from the subsequent summary and detailed description, and the appended claims, taken in conjunction with the accompanying drawings and this background.

### SUMMARY

The various teachings of the present disclosure provides a method for operating a fault diagnosis system of a vehicle, a vehicle having a fault diagnosis system, a computer program product and a computer-readable medium, which make possible an improved fault diagnosis.

According to one of various aspects of the application, a method for operating a fault diagnosis system of a vehicle, wherein the vehicle includes a plurality of electronic components and a plurality of vehicle systems, and wherein at least one of the plurality of vehicle systems can be operated by means of at least two of the plurality of electronic components, comprises the following. A determining whether at least one of the plurality of electronic components comprises a fault condition takes place. If it is determined that at least one of the plurality of electronic components comprises a fault condition, a determining which of the vehicle systems that can be operated by means of the electronic component comprising the fault condition, has caused the fault condition, takes place. In addition, a determining of an identification code that is assigned to the vehicle system causing the fault condition takes place. In addition, a storing of a fault entry takes place, wherein the fault entry includes the identification code.

The method according to the mentioned exemplary embodiment makes possible a further improved fault diagnosis. This takes place through the determining of an identification code that is assigned to the vehicle system causing the fault condition and the storing of a fault entry including the identification code. This is based on the consideration that by determining and storing the identification code in particular in the case of vehicle systems that can be operated by means of a plurality of electronic components, i.e. vehicle systems representing a distributed functionality, improved analysis possibilities both in operation as well as in the development of the vehicle can be provided. This makes possible an increase of the accuracy and effectiveness of vehicle diagnosis mechanisms and an improved detection of consequential faults within a distributed function. Furthermore, function-specific quality analyses based on statistical error rates.

In addition, the fault entry generally includes a code characterizing the fault condition. This makes possible a further improved diagnosis of possible causes for the fault condition.

In another exemplary embodiment, a point of time is additionally determined at which the fault condition has occurred. The fault entry in this embodiment additionally includes a parameter characterizing the point of time of the occurrence of the fault condition. By providing a time stamp for the fault entry, a further increase of the accuracy and effectiveness of the fault diagnosis system is made possible in an advantageous manner.

The parameter characterizing the point of time of the occurrence of the fault condition in this case can in particular include a period of time characterizing the operating duration of the vehicle. Because of this, a uniform time stamp format is provided, as a result of which dependencies between a plurality of error codes can be detected to an improved degree.

In the case that on the electronic component comprising the fault condition a plurality of software-based programs can be operated, it is additionally determined in a further configuration of the method which program has caused the fault condition. The fault entry in this configuration additionally includes an identification code that is assigned to the program causing the fault condition. Providing such an identification code, for example in the form of a software identification number, makes possible in an advantageous manner a further increase of the accuracy and of the effectiveness of the fault diagnosis system. This is based on the consideration that in vehicles a plurality of software components are integrated on an electronic component to an increased degree, wherein the software-based programs in particular can originate from different manufacturers. The mentioned configuration of the method in this case makes possible manufacturer-specific quality analyses based on statistical error rates of the difference of the components.

The fault entry is generally stored in a storage unit having a non-volatile memory. Because of this, the fault entry is available also with switched-off vehicle or interrupted energy supply, in one example, with disconnected vehicle battery.

The application additionally relates to a vehicle comprising a plurality of electronic components. In addition, the vehicle comprises a plurality of vehicle systems, wherein at least one of the plurality of vehicle systems can be operated by means of at least two of the plurality of electronic components and wherein the vehicle systems are each assigned at least one identification code characterizing the individual vehicle system. Furthermore, the vehicle comprises a fault diagnosis system with at least one storage unit. The fault diagnosis system is designed for determining if at least one of the plurality of electronic components comprises a fault condition and if it is determined that the at least one of the plurality of electronic components comprises a fault condition, to determine which of the vehicle systems that can be operated by means of the electronic component comprising the fault condition has caused the fault condition. The fault diagnosis system is furthermore designed for storing a fault entry in the at least one storage unit, wherein the fault entry includes an identification code assigned to the vehicle system causing the fault condition.

The vehicle according to the application has the advantages already mentioned in connection with the method according to the application, which are not mentioned again at this point to avoid repetitions.

The at least one storage unit is generally part of the electronic component comprising the fault condition. Thus, the fault entry can be directly stored on the electronic component concerned. Furthermore, the at least one storage unit can comprise a non-volatile memory.

The fault diagnosis system is formed in an exemplary embodiment for storing the fault entry in the storage unit, wherein the fault entry additionally includes a code characterizing the fault condition.

In addition to this, the fault diagnosis system can be additionally designed for determining a point of time at which the fault condition has occurred, and for storing the fault entry in the storage unit, wherein the fault entry additionally includes a parameter characterizing the point of time of the occurrence of the fault condition.

In another exemplary embodiment, the fault diagnosis is additionally designed for determining which program has caused the fault condition in the case that on the electronic component comprising the fault condition a plurality of software-based programs can be operated. The fault diagnosis system in this embodiment is additionally designed for storing the fault entry in the storage unit, wherein the fault entry additionally includes an identification code assigned to the program causing the fault condition.

The at least one of the plurality of vehicle systems is generally selected from the group comprising a driving dynamics control system, a drive control system, an energy management system, in one example, a battery management system, an occupant comfort control system, an electronic parking brake system, a navigation system, an information and entertainment system, a telematic system, a distance control system and a driver assistance system. The mentioned vehicle systems in this case constitute systems having functionalities distributed over a plurality of electronic components and are increasingly provided for vehicles.

The electronic components are for example designed as electronic or regulating units which are also designed ECU (ECU, electronic control unit).

Furthermore, the application relates to a device for operating a fault diagnosis system of a vehicle, wherein the vehicle includes a plurality of electronic components and a plurality of vehicle systems, wherein at least one of the plurality of vehicle systems can be operated by means of at least two of the plurality of electronic components. The device comprises means for determining if at least one of the plurality of electronic components comprises a fault condition. In addition, the device comprises means for determining which of the vehicle systems that can be operated by means of the electronic component comprising the fault condition has caused the fault condition, if it is determined that at least one of the plurality of electronic components comprises a fault condition. Furthermore, the device comprises means for determining an identification code that is assigned to the vehicle system causing the fault condition, and means for storing a fault entry, wherein the fault entry includes the identification code.

Furthermore, the application relates to a computer program product which, when it is executed on a computer unit of a fault diagnosis system of a vehicle, wherein the vehicle includes a plurality of electronic components and a plurality of vehicle systems and wherein at least one of the plurality of vehicle systems can be operated by means of at least two of the plurality of electronic components, instructs the computer unit to carry out the following. The computer unit is instructed to determine if at least one of the plurality of electronic components comprises a fault condition. If it determined that at least one of the plurality of electronic components comprises a fault condition, the computer unit is instructed to determine which of the vehicle systems, which can be operated by means of the electronic component comprising the fault condition has caused the fault condition. The computer unit is additionally instructed to determine an identification code that is assigned to the vehicle system causing the fault condition. Furthermore, the computer unit is instructed to store a fault entry, wherein the fault entry includes the identification code.

Moreover, the application relates to a computer-readable medium on which a computer program product according to the mentioned exemplary embodiment is stored.

The computer program product and the computer-readable medium according to the application comprise the advantages already mentioned in connection with the method according to the application, which are not mentioned again at this point to avoid repetitions.

The identification code in the abovementioned embodiments can be stored for example in the form of an identification number.

In the abovementioned exemplary embodiments, the vehicle is for example a motor vehicle, in one example, a passenger car or a commercial vehicle. The vehicle in this case can be designed in one example, as electric or hybrid vehicle.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 shows a flow diagram of a method for operating a fault diagnosis system of a vehicle according to an exemplary embodiment of the application;

FIG. 2 shows a flow diagram of a method for operating a fault diagnosis system of a vehicle according to another exemplary embodiment of the application;

FIG. 3 shows a flow diagram of a method for operating a fault diagnosis system of a vehicle according to another exemplary embodiment of the application;

FIG. 4 shows a flow diagram of a method for operating a fault diagnosis system of a vehicle according to another exemplary embodiment of the application; and

FIG. 5 shows a vehicle with a fault diagnosis system according to an exemplary embodiment of the application.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

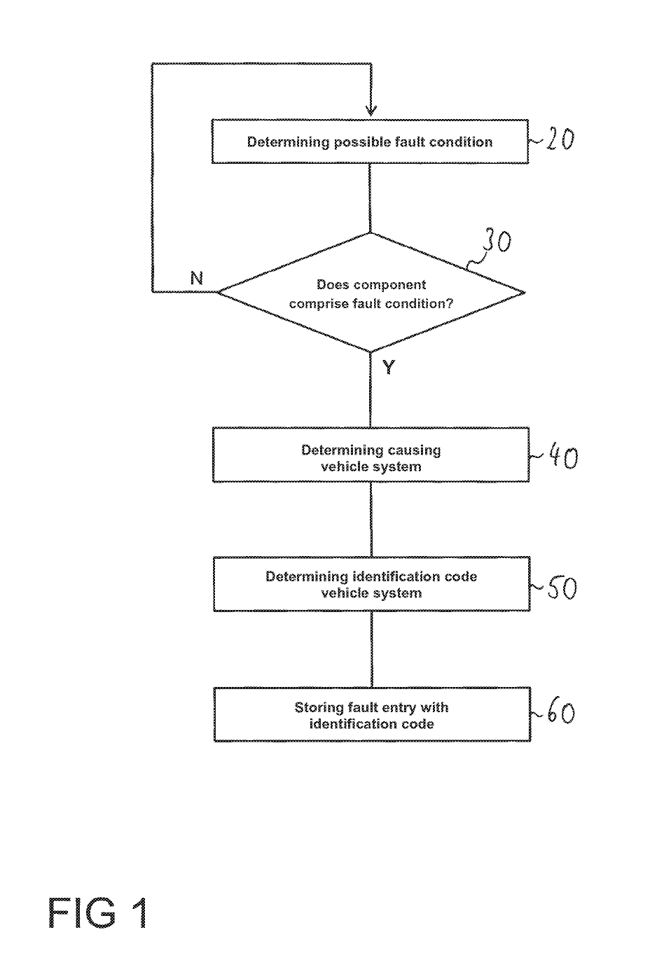

FIG. 1 shows a flow diagram of a method for operating a fault diagnosis system of a vehicle according to an exemplary embodiment of the application.

The vehicle includes a plurality of electronic components and a plurality of vehicle systems, wherein at least one of the plurality of vehicle systems can be operated by means of at least two of the plurality of electronic components. For example, the vehicle is a motor vehicle, in one example, a passenger car or a commercial vehicle.

In block 20, a monitoring of the electronic components for possible fault conditions takes place. To this end, each of the plurality of electronic components for example comprises a separate diagnostic unit by means of which fault conditions of the respective electronic components can be determined.

Based on the data determined in block 20, it is determined in block 30 if at least one of the plurality of electronic components comprises a fault condition. If none of the plurality of electronic components comprises a fault condition, blocks 20 and 30 are carried out repeatedly.

If, by contrast, it is determined in block 30 that at least one of the plurality of electronic components comprises a fault condition, a determining as to which of the vehicle systems that can be operated by means of the electronic component comprising the fault condition has caused the fault condition takes place in block 40. This is carried out for example by means of the diagnostic unit of the electronic component comprising the fault condition.

In block 50, a determining of an identification code that is assigned to the vehicle system causing the fault condition takes place. To this end, the identification code is selected for example from a plurality of identification codes stored on a storage unit.

Furthermore, a storing of a fault condition takes place in block 60, wherein the fault entry includes the identification code. The fault entry is generally stored in a storage unit with a non-volatile memory, wherein the storage unit can be part of the electronic component comprising the fault condition. In one example, the storage unit can be part of the diagnostic unit of the relevant electronic component.

In addition, a notification to the occupants of the vehicle can be output, for example in the form of an acoustic and/or visual warning message in order to notify in one example, the driver of the vehicle regarding the fault condition.

The mentioned exemplary embodiment thus makes possible an increase of the accuracy and effectiveness of vehicle diagnosis mechanisms by introducing an identification code, for example in the form of an identification number, for distributed functionalities for diagnostic purposes.

This is based on the consideration that functions are increasingly realized as system distributed over a plurality of electronic components, in one example, as system distributed over a plurality of electronic modules or electronic control or regulating units, which are also designated ECU. In the shown exemplary embodiment, the introduction and storage of an identification number for distributed function takes place, wherein the storing of the identification numbers takes place in the non-volatile memory of the ECU, for example in a flash memory of the ECU. The storing in this case can take place in standardized diagnostic mechanisms, for example as so-called failure records in order to make possible a simple reading out.

Thus, the mentioned method provides improved analysis possibilities both during the operation of the vehicle as well as in the development, for example for identifying the distributed functions concerned. In one example, the method makes possible an improved detection of consequential faults within a distributed function as well as function-specific quality analyses based on statistical error rates. Because of this, the customer satisfaction can be increased in that repeated visits of the user to a dealer or a workshop based on fault conditions which cannot be determined and/or reproduced in the workshop are avoided.

The method is suitable to a particularly high degree for energy-efficiency strategies such as for example stop/start systems and for electric vehicles or electric vehicles with extended range, which can also be designated EREV (EREC, extended range electrified vehicle).

In one example, in the case of motor vehicles, there is a move away from the approach of providing a function by means of a single electronic component and an increasing move in the direction of the development of integrated system architectures, such as for example AUTOSAR (AUTomotive Open System ARchitecture). Thus, more and more electronic functions that can be perceived by the user are configured as distributed vehicle systems, i.e. no longer realized by means of a single ECU, but by means of a plurality of for example electronic control or regulating units. In particular energy-efficiency strategies increasingly require coordinated functions through a plurality of control or regulating units within the vehicle.

By means of the mentioned method for operating a fault diagnosis system, an improved determining of the function or of the vehicle system having originally caused the system fault condition is made possible. To this end, structural information is stored in the fault entry, i.e. the identification of the function causing the fault condition.

The availability of detailed information regarding distributed functions in connection with the diagnosis entry increases the accuracy of the diagnostic unit by providing possibilities for the improved determining of the component causing the fault condition. This is advantageous in particular in the case that a plurality of vehicle systems of different manufacturers are integrated in an electronic component. Through this information, the repair strategy can be adapted and statistical information of the fault types and the quality of the different functions can be determined Those last mentioned are important characteristics for the quality, the first-mentioned aspect has particular influence on warranty costs since a potential reduction of the number of electronic components to be replaced is made possible. This is based on the consideration that the replacing of the electronic components in the case of distributed vehicle systems does not necessarily make possible a rectification of the fault since the electronic component includes only parts of the distributed functionality. Furthermore, the identification code or the identification number simplifies the identification of time-sequential faults that are distributed over a plurality of electronic components. The mentioned method thus makes possible the reduction of warranty costs, a further improvement of the service quality and an improved user satisfaction.

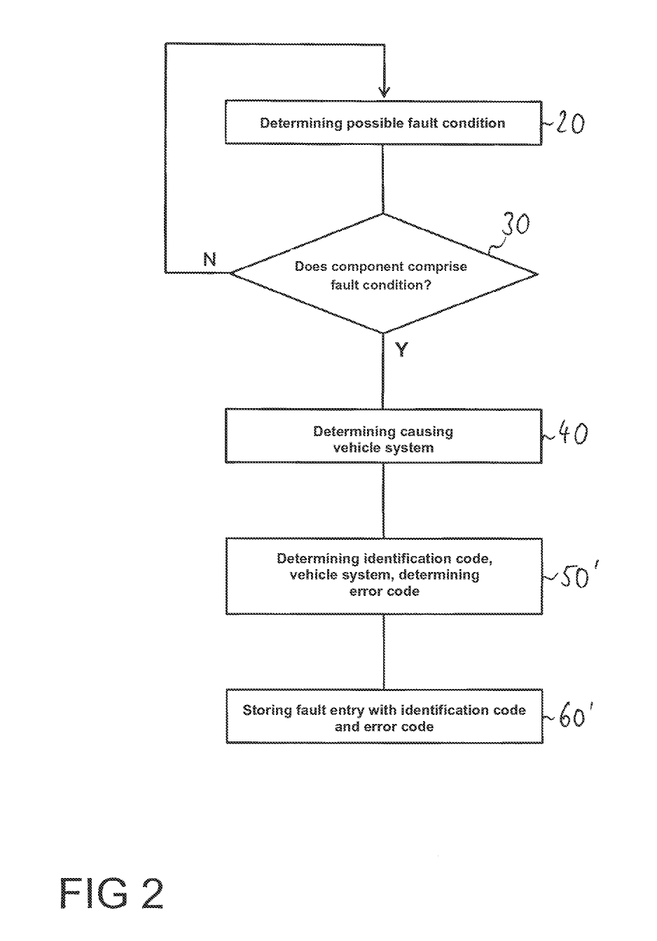

FIG. 2 shows a flow diagram of a method for operating a fault diagnosis system of a vehicle according to another exemplary embodiment of the application.

The vehicle includes a plurality of electronic components and a plurality of vehicle systems, where at least one of the plurality of vehicle systems can be operated by means of two of the plurality of electronic components. The vehicle is for example a motor vehicle, in one example, a passenger car.

In block 20, a monitoring of the electronic components for possible fault conditions corresponding to the block 20 of the exemplary embodiment shown in FIG. 1 takes place.

In block 30, it is determined based on the data determined in the block 20 if at least one of the plurality of electronic components comprises a fault condition.

If none of the plurality of electronic components comprises a fault condition, the blocks 20 and 30 are carried out repeatedly.

If, however, it is determined that at least one of the plurality of electronic components comprises a fault condition, a determining as to which of the vehicle systems that can be operated by means of the electronic component comprising the fault condition, has caused the fault condition takes place in block 40. This takes place according to the block 40 of the exemplary embodiment shown in FIG. 1.

In block 50′, an identification code is determined that is assigned to the vehicle system causing the fault condition. In addition, a code characterizing the fault condition is determined in block 50′.

In block 60′, a storing of a fault entry takes place, wherein the fault entry includes the identification code and the code characterizing the fault condition. The fault entry in this case can be stored in a storage unit with a non-volatile memory, wherein the storage unit is in one example, part of the electronic component comprising the fault condition.

In addition, a notification can be output to the occupants of the vehicle, for example in the form of an acoustic and/or visual warning message, in order to notify in one example, the driver of the vehicle regarding the fault condition.

Thus, in the mentioned exemplary embodiment, the identification code, for example in the form of an identification number, as well as an error code, which is also designated DTC (DTC, diagnostic trouble code), are typically stored in the diagnostic unit of the electronic component after a determined fault condition. Here, a common mechanism for storing additional information to the error code or the DTC can be employed, for example in the form of an error data set. This error data set can subsequently be read out in a workshop in order to determine from it information regarding a repair.

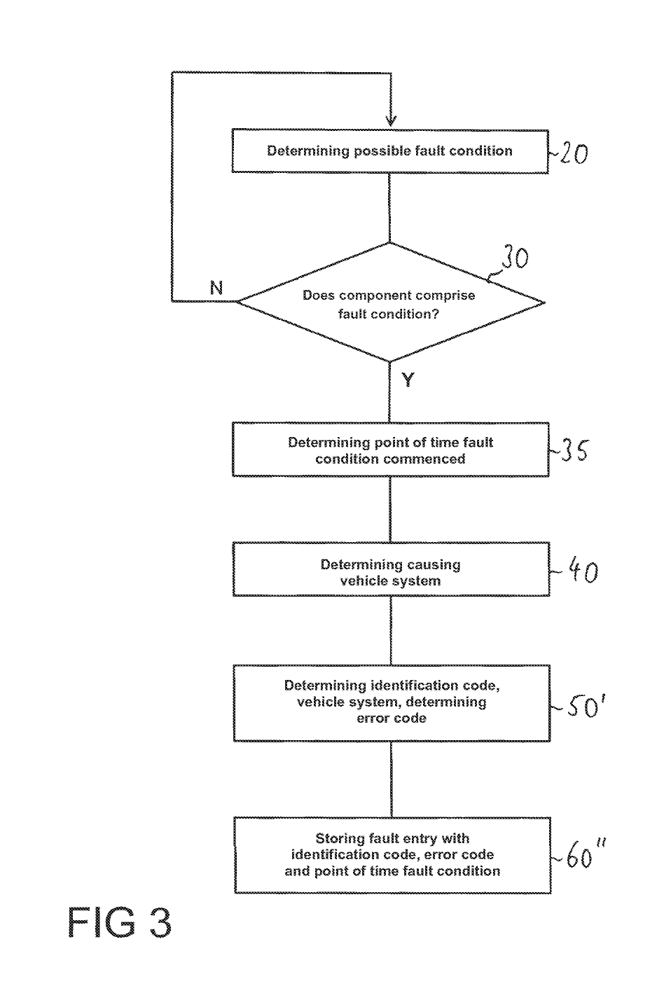

FIG. 3 shows a flow diagram of a method for operating a fault diagnosis system of a vehicle according to another exemplary embodiment of the application.

Again, the vehicle includes a plurality of electronic components and a plurality of vehicle systems, wherein at least one of the plurality of vehicle systems can be operated by means of at least two of the plurality of electronic components. For example, the vehicle is a motor vehicle, in one example, a passenger car.

In block 20, a monitoring of the electronic components for possible fault conditions takes place. This takes place according to the block 20 of the exemplary embodiment shown in FIG. 1.

In block 30, based on the data determined in the block 20, it is determined if at least one of the plurality of electronic components comprises a fault condition.

If none of the plurality of electronic components comprises a fault condition, the blocks 20 and 30 are carried out repeatedly.

If, however, it is determined in block 30 that at least one of the plurality of electronic components comprises a fault condition, a point of time is determined in the shown exemplary embodiment in block 35, at which the fault condition commenced or occurred. For example, the operating duration of the vehicle at the point of time of the commencement of the fault condition is determined. In one example, the operating duration of the vehicle in seconds can be determined.

In block 40, a determining as to which of the vehicle systems that can be operated by means of the electronic component comprising the fault condition, caused the fault condition takes place. This takes place according to block 40 of the exemplary embodiment shown in FIG. 1.

In block 50′, an identification code, which is assigned to the vehicle system causing the fault condition, and a code characterizing the fault condition is determined, corresponding to block 50′ of the exemplary embodiment shown in FIG. 2.

Furthermore, a fault entry is stored in a storage unit in block 50″, wherein the fault entry includes the identification code and in addition the code characterizing the fault condition and a parameter characterizing the point of time of the commencement of the fault condition. The last-mentioned parameter can for example include the operating duration of the vehicle, which in one example, can be given in seconds.

In addition, a notification can be output to the occupants of the vehicle, for example in the form of an acoustic and/or visual warning message in order to notify in one example, the driver of the vehicle regarding the fault condition.

In the shown exemplary embodiment, a time stamp mechanism is thus additionally provided for diagnostic purposes. Here, a storing of a time stamp in conjunction with the respective error code and the identification code takes place as soon as a fault is detected. In one example, a uniform time stamp format such as the operating duration of the vehicle in seconds is employed in order to be able to easily detect dependencies between error codes of different electronic components. The storing of the time stamp generally takes place in a non-volatile memory of the ECU, for example in a flash memory, and can take place in standardized diagnostic mechanisms, for example in the form of so-called failure records in order to make possible a simple reading out.

The mentioned exemplary embodiment thus makes possible a further reduction of fault diagnoses and erroneously replaced electronic components. To this end, the fault entry can be read out in a workshop and in one example, evaluated automatically in order to correlate different fault messages with one another. This makes possible in particular the identification of time sequential fault conditions through technically traceable data. Because of this, the number of erroneously replaced functioning components can be further reduced.

An example of a use of the mentioned method is an electronic parking brake system. Here, in addition to a main component, additional sensor information of other electronic components is required in order to provide all features of the system. For example, sensor information regarding the wheel speed is provided via a vehicle-own network. The wheel speed sensors to this end are connected to an electronic brake control module which is also designated EBCM (EBCM, electronic brake control module). A reduced supply voltage to the EBCM, which for example is caused by a corroded connecting element, can result in that the wheel speed sensor data is classified as defective and a fault entry is stored in a storage device of the EBCM. In addition, a fault entry can be stored in a storage device of the electronic parking brake system. By providing a time stamp in the fault entries, an in particular automatic reconstruction of causality chain and a direct correlation of the two fault entries can take place.

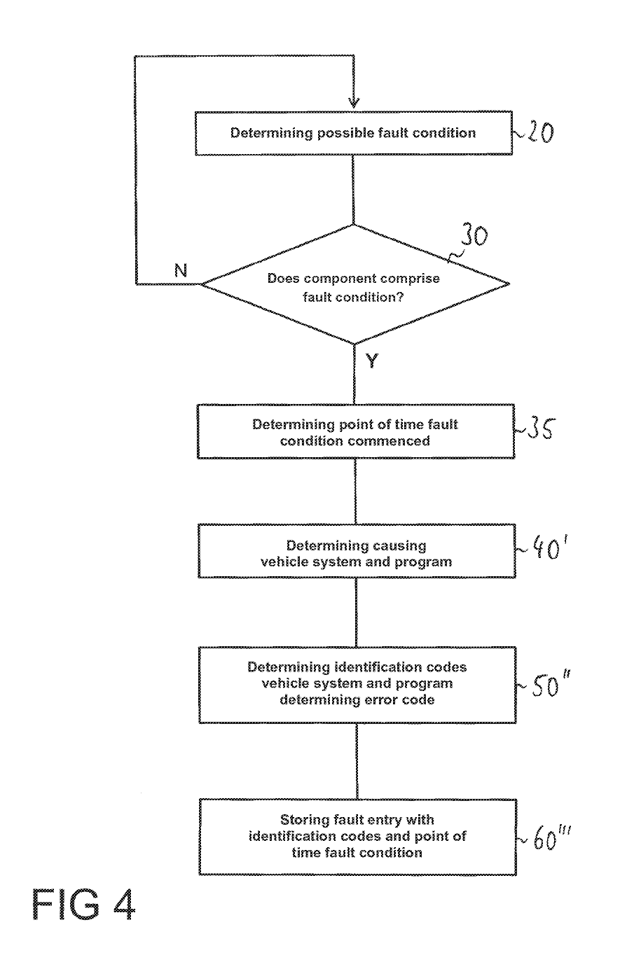

FIG. 4 shows a flow diagram of a method for operating a fault diagnosis system of a vehicle according to another exemplary embodiment of the application.

The vehicle includes a plurality of electronic components and a plurality of vehicle systems, wherein at least one of the plurality of vehicle systems can be operated by means of at least two of the plurality of electronic components. For example, the vehicle is a motor vehicle, in one example, a passenger car.

In block 20, a monitoring of the electronic components for possible fault conditions takes place. This takes place according to block 20 of the exemplary embodiment shown in FIG. 1.

In block 30 it is determined if at least one of the plurality of electronic components comprises a fault condition.

If none of the plurality of electronic components comprises a fault condition, the blocks 20 and 30 are carried out repeatedly.

If, however, it is determined that at least one of the plurality of electronic components comprises a fault condition, it is a point of time at which the fault condition commenced is determined in block 35. This takes place according to block 35 of the exemplary embodiment shown in FIG. 3.

Furthermore it is determined in block 40′, which of the vehicle systems that can be operated by means of the electronic component comprising the fault condition, has caused the fault condition. If on the electronic component comprising the fault condition a plurality of software-based programs can be operated, it is additionally determined in the shown exemplary embodiment which program caused the fault condition. This takes place for example by means of the diagnostic unit of the electronic component concerned.

In block 50″, an identification code, which is assigned to the vehicle system causing the fault condition, and an identification code, which is assigned to the program causing the fault condition, are determined. Furthermore, a code characterizing the fault condition is determined in block 50″.

In addition to this, a storing of a fault entry takes place in block 60′″, wherein the fault entry includes the identification code, which is assigned to the vehicle system causing the fault condition and the identification code, which is assigned to the program causing the fault condition. Furthermore, the fault entry includes the code characterizing the fault condition and a parameter characterizing the point of time of the occurrence of the fault condition. The fault entry is stored for example in a storage unit of the electronic component comprising the fault condition, generally in a non-volatile memory.

In addition, a notification can be output to the occupants of the vehicle, for example in the form of an acoustic and/or visual warning message in order to notify in one example, the driver of the vehicle regarding the fault condition.

In the mentioned exemplary embodiment, an identification code for example in the form of a software identification number is thus additionally provided for diagnostic purposes. This is based on the consideration that increasingly software components of a plurality of manufacturers are integrated in an electronic component, in particular in an ECU. By means of the mentioned embodiment, improved analysis possibilities for identifying a defective software component of a certain manufacturer can be provided and manufacturer-specific quality analyses based on statistical error rates of the difference of the components made possible. This is advantageous in particular with software architectures such as AUTOSAR (AUTomotive Open System ARchitecture).

The identification code assigned to the program causing the fault condition can in particular include a parameter characterizing the manufacturer of the program for this purpose. This makes possible the identification of a potentially defective software component which was provided by a certain manufacturer. In addition, the fault entry can include the number of software-based programs that can be operated on the electronic component comprising the fault condition.

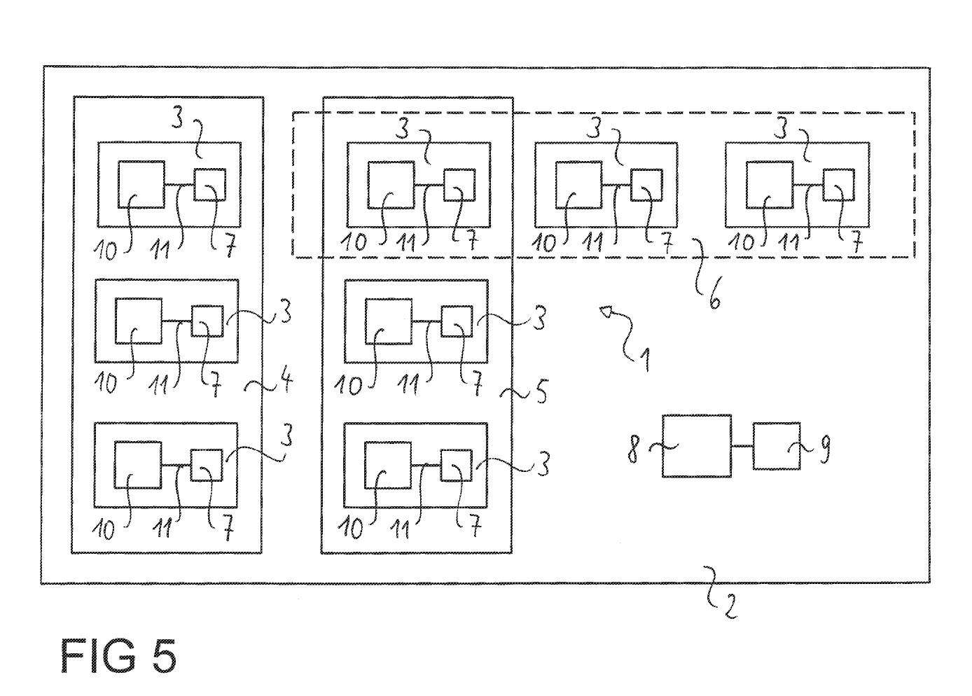

FIG. 5 shows a schematic representation of a vehicle 2 with a fault diagnosis system 1 according to an exemplary embodiment of the application.

The vehicle 2 is for example a motor vehicle, in one example, a passenger car, and comprises a plurality of electronic components 3. The electronic components 3 are for example control units, regulating units or sensors. In addition, the vehicle 2 comprises a plurality of vehicle systems 4, 5 and 6. For example, the vehicle system 4 forms a driving dynamics control system, the vehicle system 5 a drive control system and a vehicle system 6 an electronic parking brake system of the vehicle 2. The vehicle systems 4, 5 and 6 in the shown exemplary embodiment are each assigned at least one identification code characterizing the individual vehicle system.

The vehicle systems 4, 5 and 6 form distributed systems, i.e. their functionality is distributed over a plurality of the electronic components 3. For example, the driving dynamics control system includes electronic components 3 for determining engine control data, steering wheel angle data and rotational speed data as well as further control units and display devices.

In the shown exemplary embodiment, the vehicle systems 4, 5 and 6 can be operated by means of a plurality of the electronic components 3, of which for reasons of clarity three electronic components 3 each are shown for each vehicle system. The electronic components 3 are thus part of one or a plurality of the vehicle systems 4, 5 and 6.

In the shown exemplary embodiment, each of the electronic components 3 comprises a diagnostic unit 10, which is designed for determining fault conditions of the respective electronic component 3. In addition to this, each of the electronic components 3 comprises a storage unit 7 for storing fault entries. The storage unit 7 to this end is connected to the respective diagnostic unit 10 via a signal line 11. In the shown exemplary embodiment, the storage unit 7 in this case comprises a non-volatile memory.

The fault diagnosis system 1 of the vehicle 2 is designed for determining if at least one of the plurality of electronic components 3 comprises a fault condition, and, if it is determined that at least one of the plurality of electronic components 3 comprises a fault condition, to determine which of the vehicle systems, that can be operated by means of the electronic component 3 comprising the fault condition, has caused the fault condition. In addition, the fault diagnosis system 1 is designed for determining an identification code that is assigned to the vehicle system causing the fault condition. Furthermore, the fault diagnosis system 1 is designed for storing a fault entry in that storage unit 7, which is part of the electronic component 3 comprising the fault condition, wherein the fault condition includes the identification code assigned to the vehicle system causing the fault condition.

In the shown exemplary embodiment, the fault diagnosis system 1 is additionally designed for determining a code characterizing the fault condition and for storing the fault entry in the respective storage unit 7, wherein the fault entry additionally includes the code characterizing the fault condition.

Furthermore, the fault diagnosis system 1 is designed for determining a point of time at which the fault condition commenced, and for storing the fault entry in the storage unit 7 of the corresponding electronic component, wherein the fault entry in addition includes a parameter characterizing the point of time of the commencement of the fault condition.

The fault diagnosis system 1 in the shown exemplary embodiment is additionally designed for determining which program has caused the fault condition, if on the electronic component comprising the fault condition a plurality of software-based programs can be operated. In addition, the fault diagnosis system 1 is designed for storing the fault entry in the corresponding storage unit 7, wherein the fault entry additionally includes an identification code assigned to the program causing the fault condition.

The vehicle 2 in the shown exemplary embodiment furthermore comprises a computer unit 8 and a computer-readable medium 9, wherein on the computer-readable medium 9 a computer program product is stored, which, when it is executed on the computer unit 8, instructs the computer unit 8 to carry out by means of the elements mentioned there the routine mentioned in connection with the exemplary embodiments of the method according to the application, in one example, the method of the embodiments shown in the FIGS. 1 to 4. To this end, the computer unit 8 is directly or indirectly connected to the relevant elements in a manner which is not shown in more detail.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. A method for operating a fault diagnosis system of a vehicle, the vehicle including a plurality of electronic components and a plurality of vehicle systems, with at least one of the plurality of vehicle systems operable by means of at least two of the plurality of electronic components, the method comprising:
determining if at least one of the plurality of electronic components comprises a fault condition;
if it is determined that at least one of the plurality of electronic components comprises a fault condition, determining as to which of the vehicle systems operable by means of the electronic component comprising the fault condition, has caused the fault condition;
determining an identification code that is assigned to the vehicle system causing the fault condition; and
storing a fault entry that includes the identification code.

2. The method according to claim 1, wherein the fault entry additionally includes a code characterizing the fault condition.

3. The method according to claim 1, wherein in addition a point of time is determined at which the fault condition commenced and wherein the fault entry additionally includes a parameter characterizing the point of time of the commencement of the fault condition.

4. The method according to claim 3, wherein the parameter characterizing the point of time of the commencement of the fault condition includes a time duration characterizing the operating duration of the vehicle.

5. The method according to claim 1, wherein, if on the electronic component comprising the fault condition a plurality of software-based programs is operable, the method further comprises:
determining which program has caused the fault condition, and
wherein the fault entry additionally includes an identification code assigned to the program causing the fault condition.

6. The method according to claim 1, wherein the fault entry is stored in a storage unit with a non-volatile memory.

7. A vehicle, comprising:
a plurality of electronic components;
a plurality of vehicle systems, at least one of the plurality of vehicle systems operable by means of at least two of the plurality of electronic components and the vehicle systems are each assigned at least one identification code characterizing the individual vehicle system; and
a fault diagnosis system with at least one storage unit,
wherein the fault diagnosis system determines if at least one of the plurality of electronic components comprises a fault condition and, if it is determined that at least one of the plurality of electronic components comprises a fault condition, determines which of the vehicle systems operable by means of the electronic component comprising the fault condition, has caused the fault condition, stores a fault entry in the at least one storage unit, and the fault entry includes an identification code assigned to the vehicle system causing the fault condition.

8. The vehicle according to claim 7, wherein the at least one storage unit is part of the electronic component comprising the fault condition.

9. The vehicle according to claim 8, wherein the at least one storage unit comprises a non-volatile memory.

10. The vehicle according to claim 9, wherein the fault diagnosis system stores the fault entry in the storage unit, and the fault entry additionally includes a code characterizing the fault condition.

11. The vehicle according to claim 10, wherein the fault diagnosis system determines a point of time at which the fault condition commenced and stores the fault entry in the storage unit, wherein the fault entry additionally includes a parameter characterizing the point of time of the commencement of the fault condition.

12. The vehicle according to claim 11, wherein the fault diagnosis system determines which program has caused the fault condition, and if on the electronic component comprising the fault condition a plurality of software-based programs is operable, stores the fault entry in the storage unit, with the fault entry including an identification code assigned to the program causing the fault condition.

13. The vehicle according to claim 12, wherein the at least one of the plurality of vehicle systems is selected from the group comprising: a driving dynamics control system, a drive control system, an energy management system, an occupant comfort control system, a navigation system, an information and entertainment system, a telematic system and a driver assistance system.

14. A computer program product, comprising:
a storage medium readable by a computer unit of a fault diagnosis system of a vehicle, the vehicle including a plurality of electronic components and a plurality of vehicle systems, with at least one of the plurality of vehicle systems operable by means of at least two of the plurality of electronic components, the storage medium storing instructions for execution by the computer unit for performing a method comprising:
determining if at least one of the plurality of electronic components comprises a fault condition;
if it is determined that at least one of the plurality of electronic components comprises a fault condition, determining which of the vehicle systems operable by means of the electronic component comprising the fault condition, has caused the fault condition;
determining an identification code that is assigned to the vehicle system causing the fault condition; and
storing a fault entry that includes the identification code.
